(19) United States
(12) Patent Application Publication
(10) Pub. No.: US 2022/0129538 A1
(43) Pub. Date: Apr. 28, 2022

(54) PASSWORD INTEGRITY SCORING

(71) Applicant: Hewlett-Packard Development Company, L.P., Spring, TX (US)

(72) Inventors: Shane I. Saunders, Fort Collins, CO (US); Leonardo Eloy Abranques de Oliveira, Fort Collins, CO (US); Christopher Ray Myers, Vancouver, WA (US); Paul Michael Anderson, Fort Collins, CO (US)

(73) Assignee: Hewlett-Packard Development Company, L.P., Spring, TX (US)

(21) Appl. No.: 17/418,281

(22) PCT Filed: Jul. 19, 2019
(86) PCT No.: PCT/US2019/042578

§ 371 Date: Jun. 25, 2021

(51) Int. Cl. G06F 21/46

(52) U.S. Cl. CPC G06F 21/46

(57) ABSTRACT

Examples of password integrity scoring are described. In an example, an integrity score for a password may be determined based on a comparison of the password with a set of passwords for multiple users stored in a database. In some examples, the set of passwords may include in-use passwords and previously-used passwords for the multiple users. In some examples, the password may be stored into the database for scoring future passwords.

### BACKGROUND

Passwords may be used by computing devices to authenticate a user or application. Passwords may be a secret that is shared to confirm the identity of a user or application. In some examples, a password may be used in an authentication process in which a user or application establishes their identity to gain access to a resource or system. Many authentication systems use password-based authentication.

### BRIEF DESCRIPTION OF THE DRAWINGS

Various examples will be described below by referring to the following figures.

FIG. 1 is a block diagram of an example of a computing device that may determine an integrity score for a password;

FIG. 2 is a flow diagram illustrating an example of a method for password integrity scoring;

FIG. 3 is a flow diagram illustrating another example of a method for password integrity scoring;

FIG. 4 is a flow diagram illustrating another example of a method for password integrity scoring; and

FIG. 5 is a flow diagram illustrating yet another example of a method for password integrity scoring.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations in accordance with the description; however, the description is not limited to the examples and/or implementations provided in the drawings.

### DETAILED DESCRIPTION

The techniques described herein relate to password integrity scoring. As used herein a “password” is secret information that is associated with a particular user or application (e.g., a program implemented by a computing device). A password may include a phrase (e.g., character, numbers, symbols) or other secret (e.g., a cryptographic key). In some examples, passwords may be used in systems both for human users and applications.

Password integrity is an indication of the security of a password. In some cases, passwords may become exposed (e.g., compromised) through a data breach. In other cases, a password may become widely used within an organization or within society in general. For instance, passwords may be created that incorporate phrases based on popular social events. Determining when a password is likely to be breached or when the password is being used more frequently can help reduce the risk of account exposure. An integrity score of the password may be determined to indicate the likelihood of the password becoming breached.

In some examples, bad passwords can be described as passwords that are commonly used or are known to be compromised passwords. In these cases, these bad passwords may be low integrity passwords.

In some examples, a check for bad passwords may be executed by a credential system. However, this may be difficult for a credential system to implement, especially a check for commonly used passwords. For example, a credential system may have access to its own passwords, however those passwords may be stored in a way that cannot be scanned for prior use (e.g., passwords may be hashed) in an efficient manner. Even if the passwords could be scanned by a credential system, having access to the passwords stored in one system may not be enough data points to determine if a password is commonly used.

In another approach, a password may be checked against a list of known breached passwords. While this approach may indicate whether a password has been used in a known data breach, this approach does not check if the password is common, in general. Furthermore, this approach does not validate a password against a list of prior passwords that may not have been breached to calculate the likelihood of a password becoming insecure.

This disclosure relates to determining a password integrity score that indicates the likelihood of the password becoming insecure. In some examples, methods to aggregate passwords, as well as keep a list of known bad passwords collected from other sources are also described herein. In some examples, the password integrity check may be offered as a service and passwords could then be validated using online validation and return an integrity score as to the likelihood of a password being compromised.

In some examples, a computing device for scoring the password integrity (also referred to as password virtue) is described. As used herein, the password integrity is the likelihood that the password will be compromised. In some examples, a user may enter a password on a user interface (e.g., graphical user interface). In some examples, the computing device may receive the password from another computing device, automated system, service or application. In some examples, the computing device may also receive an application identifier and integrity scoring parameters.

The integrity scoring parameters may include a length of time to store the password for later integrity scoring against other passwords (including never), a length of time to check for previous passwords and whether the password metadata may be shared among other application users of the system.

The computing device may check the password that the user entered with other in-use passwords and previously-used passwords. After the comparison, the computing device may provide an integrity score for the password indicating the uniqueness of the password or how likely it is to be compromised.

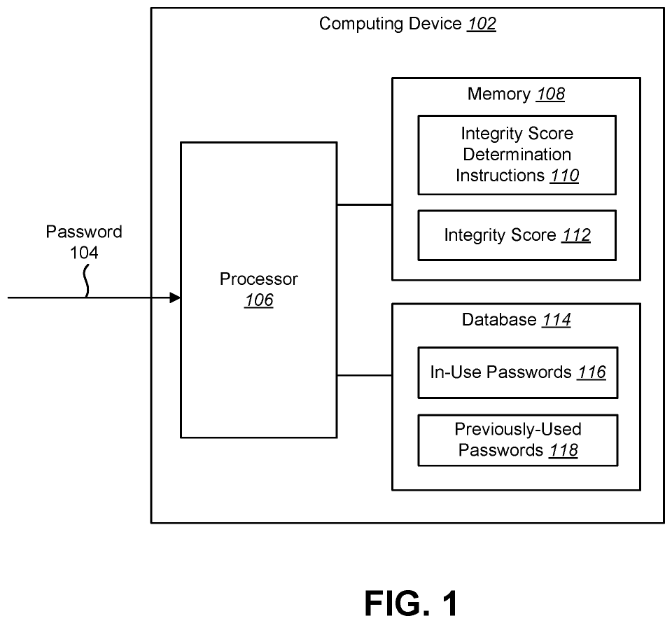

FIG. 1 is a block diagram of an example of a computing device 102 that may determine an integrity score 112 for a password 104. The computing device 102 may be an electronic device, such as a server computer, a personal computer, a smartphone, a tablet computer, etc. The computing device 102 may include and/or may be coupled to a processor 106 and/or a memory 108. In some examples, the computing device 102 may include a display and/or an input/output interface. In some examples, the computing device 102 may be in communication with (e.g., coupled to, have a communication link with) an external device (e.g., a server computer, a personal computer, a smartphone, a tablet computer, etc.). The computing device 102 may include additional components (not shown) and/or some of the components described herein may be removed and/or modified without departing from the scope of this disclosure.

The processor 106 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 108. The processor 106 may fetch, decode, and/or execute instructions (e.g., integrity score determination instructions 110) stored in the memory 108. In some examples, the processor 106 may include an electronic circuit or circuits that include electronic components for performing a function or functions of the instructions (e.g., integrity score determination instructions 110). In some examples, the processor 106 may perform one, some, or all of the functions, operations, elements, methods, etc., described in connection with one, some, or all of FIGS. 1-5.

The memory 108 may be any electronic, magnetic, optical, or other physical storage device that contains or stores electronic information (e.g., instructions and/or data). The memory 108 may be, for example, Random Access Memory (RAM), Electrically Erasable Programmable Read-Only Memory (EEPROM), a storage device, an optical disc, and the like. In some examples, the memory 108 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 108 may be a non-transitory tangible machine-readable storage medium, where the term “non-transitory” does not encompass transitory propagating signals. In some examples, the memory 108 may include multiple devices (e.g., a RAM card and a solid-state drive (SSD)).

In some examples, the computing device 102 may include an input/output interface through which the processor 106 may communicate with an external device or devices (not shown), for instance, to receive and store information (e.g., a password 104). The input/output interface may include hardware and/or machine-readable instructions to enable the processor 106 to communicate with the external device or devices. The input/output interface may enable a wired or wireless connection to the external device or devices (e.g., personal computer, a server computer, a smartphone, a tablet computer, etc.). The input/output interface may further include a network interface card and/or may also include hardware and/or machine-readable instructions to enable the processor 106 to communicate with various input and/or output devices, such as a keyboard, a mouse, a display, a touchscreen, a microphone, a controller, another apparatus, electronic device, computing device, etc., through which a user may input instructions into the computing device 102.

In some examples, the processor 106 may receive a password 104 from an automated system. For example, the processor 106 may receive the password 104 from a web service (e.g., networked service). In another example, an automated system may generate the password 104 and may send the password 104 to the processor 106.

In other examples, the processor 106 may receive the password 104 from a user interface. For example, the computing device 102 may communicate with a user interface that provides a password 104. In some cases, the user interface may be implemented on an external device. In other cases, the user interface may be implemented on the computing device 102. In some examples, the user interface may be a graphical user interface into which a user enters the password 104.

When a user attempts to access resources using an application, the user may be prompted to enter the password 104 into the user interface. The application and/or user interface may communicate the password 104 to the processor 106. In some examples, the processor 106 may receive the password 104 directly from the application and/or user interface. In other examples, the processor 106 may receive the password 104 from a web service acting as an intermediary for the application and/or user interface.

In some examples, the computing device 102 may communicate with a database 114 that stores of in-use passwords 116 and previously-used passwords 118 for multiple users. For example, the passwords (e.g., in-use passwords 116 and previously-used passwords 118) may be stored in a hashed format. The hashes may be salted with the same salt for each password or with various salts for the different passwords. In the case of a hashed password, the actual password cannot be derived from the hashed value. However, if the password is presented again, the hashed value will be the same as previously. This allows passwords to be stored and then validated using a known procedure, keeping the password secure. Some examples of hashing approaches include SHA-2, SHA-3, and PBKDF2.

It should be noted that in some examples, the database 114 may be stored on the computing device 102. In other examples, the database 114 may be a data store on another system (e.g., a separate computing device). Furthermore, in some examples, the in-use passwords 116 and previously-used passwords 118 may be stored on the same database 114 or the in-use passwords 116 and previously-used passwords 118 may be stored in separate databases.

In some examples, the password storage in the database 114 may not be in the clear (e.g., plaintext passwords may not be stored). Furthermore, the password storage in the database 114 may not be associated with any other user information. However, a previously entered password may be found in the database 114 to determine an integrity score 112 for the likelihood of a compromised password. To do this, a mechanism for finding a password value and maintaining the secrecy of the password values may be utilized.

In some examples, the processor 106 may receive a password 104 entered into the user interface. For example, when a user attempts to access resources using an application, the user may be prompted to enter the password 104 into the user interface. The user interface may communicate the password 104 to the processor 106.

In some examples, the processor 106 may also receive an integrity scoring parameter (or multiple integrity scoring parameters) related to the password integrity scoring. The integrity scoring parameter may be information (e.g., an instruction) that adjusts how password integrity scoring is performed. In an example, the integrity scoring parameter may include a length of time to store the password 104 for later integrity scoring against other passwords (e.g., other received passwords). In some examples, the integrity scoring parameter may be received from the source (e.g., automated system, web service, application, user interface, etc.) of the password 104.

In another example, the integrity scoring parameter may include a length of time to check for previously-used passwords 118. In this case, the integrity scoring parameter may indicate a timeframe for the previously-used passwords 118 to be included in password integrity scoring.

In another example, the integrity scoring parameter may include whether password metadata may be shared among other application users of the system. In some examples, the integrity scoring parameter may indicate whether or not an application allows its password 104 to be shared with other applications. In some examples, an application that is using the password integrity system may want their passwords to only be used for calculating the password integrity score 112 for passwords 104 coming from this application. In other words, the passwords 104 for the application may be hidden from other applications. The password metadata may be stored for use within the password scoring system (e.g., the database 114).

As an example, Application A may not want its user passwords to be mingled with passwords for Application B, and vice versa. In this example, Application A may indicate in an integrity scoring parameter that it only wants its passwords to be used within its own scoring requests. A separation between the passwords may be virtual based on the metadata, or the separation may be physical (e.g., separate data stores) based on the metadata to indicate where the data (e.g., passwords) is stored.

The processor 106 may determine an integrity score 112 for the password 104 based on a comparison of the password 104 with a set of passwords for multiple users stored in the database 114. In an example, the set of passwords may include the in-use passwords 116 and previously-used passwords 118 for the multiple users. In another example, the set of passwords may include the in-use passwords 116 without the previously-used passwords 118. In yet another example, the set of passwords may include the previously-used passwords 118 without the in-use passwords 116.

The integrity score 112 determined by the processor 106 may indicate the uniqueness of the password 104. This may be an indication of the likelihood of the password 104 being compromised. In some examples, the integrity score 112 may be based on the number of times (e.g., number of matches) that the password 104 has been used by the multiple users as represented by the in-use passwords 116 and previously-used passwords 118 in the database 114.

In some examples, the integrity score 112 may be a gradient scale indicating the likelihood of the password 104 becoming insecure. For example, the password 104 may be given an integrity score 112 between 1 and 10, where 10 is the least likely to become insecure (e.g., compromised) and 1 is the most likely to become insecure. It should be noted that other scales (e.g., between 1 and 100) may be used. Furthermore, the gradient scale of the integrity score 112 may be reversed in that 1 may be most likely to be secure and 10 may be least likely to be secure.

In some examples, the processor 106 may query the database 114 using the password 104 to determine the number of times that the password 104 has been used by the multiple users. For example, the processor 106 may query the database 114 to determine how many instances of the in-use passwords 116 and/or previously-used passwords 118 match the password 104. In some cases, the match may be a complete (e.g., 100%) match. In other cases, the match may be a partial match of the password 104 to the in-use passwords 116 and/or previously-used passwords 118.

The database 114 may return the number of passwords (e.g., the in-use passwords 116 and/or previously-used passwords 118) that match the password 104. In some examples, the database 114 may also return the number of passwords that were checked. In some other examples, the database 114 may return (or the processor 106 may determine) a percentage of in-use passwords 116 and/or previously-used passwords 118 for the multiple users that match the password 104.

The processor 106 may determine the integrity score 112 for the password 104 based on the number of times that the password 104 has been used by the multiple users. For example, the processor 106 may determine the integrity score 112 for the password 104 based on how many instances of the in-use passwords 116 and/or previously-used passwords 118 match the password 104. In an example, a high number of uses (e.g., matches) of the password 104 may result in a low integrity score 112. In other words, a high number of uses of the password 104 may indicate that the password is more likely to become insecure. In this case, the password 104 may receive a low integrity score 112. In this example, a low number of uses (e.g., matches) of the password 104 may result in a high integrity score 112. In other words, a low number of uses of the password 104 may indicate that the password is less likely to become insecure. In this case, the password 104 may receive a high integrity score 112.

In some examples, other information may also be used with the number of uses of the password 104 to determine the integrity score 112. For example, the length and/or entropy of the password 104 may be used in conjunction with the number of uses to generate the integrity score 112.

In some examples, the integrity score 112 may be determined as a floating value from 0 to 1, where 1 would be a very low likelihood of the password 104 to become insecure and 0 would be a very high likelihood of the password 104 to become insecure. It should be noted that other scales could be used for the integrity score 112.

In an example, if the query of the password 104 returns that no passwords in the database 114 matches the password 104, the password 104 may receive an integrity score 112 of “10” indicating that the password has a low likelihood of becoming insecure. In another example, if the query of the password 104 returns that 1 out of 1000 passwords in the database 114 match the password 104, the password 104 may receive an integrity score 112 of “9” indicating that the password still has a low likelihood of becoming insecure. In yet another example, if the query of the password 104 returns that 100 out of 1000 passwords in the database 114 match the password 104, the password 104 may receive an integrity score 112 of “1” indicating that the password has a high likelihood of becoming insecure. In other words, if a high number or percentage of users have used or are currently using the same password, then the password 104 has a higher likelihood of becoming insecure if one of the user's password becomes compromised.

In some examples, determining the integrity score 112 for the password 104 may include determining a percentage of in-use passwords 116 and previously-used passwords 118 for the multiple users that match the password 104. For example, a first percentage range of matches may be assigned a first integrity score 112, a second percentage range of matches may be assigned a second integrity score 112 and so forth. The higher the percentage of matches, the lower the integrity score 112 may be.

The processor 106 may store the password 104 into the database 114 for scoring future passwords based on the determined integrity score 112. For example, upon determining the integrity score 112, the processor 106 may provide the password 104 to the database 114 to store the password 104. When a future password is provided to the processor 106 for integrity scoring, the saved password 104 may be used to determine the integrity score 112 of the future password.

In some examples, the determined integrity score 112 may be saved with the password 104. The determined integrity score 112 may be used to determine the integrity score 112 of a future password. For example, if a future password matches a stored password with a low integrity score 112, the future password may also receive a low integrity score 112. This approach may be helpful if passwords are stored in the database 114 for a limited amount of time. The stored integrity score 112, may indicate the uniqueness of a stored password 104 even when the database 114 includes a partial set of stored passwords.

In other examples, the processor 106 may store the password 104 into the database 114 for scoring future passwords in response to the integrity score 112 of the password 104 exceeding a threshold. In this example, the database 114 may store passwords that have integrity scores 112 greater than a certain threshold. This approach may be helpful if low integrity passwords are rejected (e.g., not allowed to be used for authentication). This approach may avoid saving low integrity passwords in the database 114.

In some examples, the processor 106 may determine the integrity score 112 based on the received integrity scoring parameter. For example, the length of time to check for previously-used passwords 118 may be used to filter out previously-used passwords 118 that are older than a threshold amount.

In another example, the integrity scoring parameter may include a length of time (including never) to store the password 104 for later integrity scoring against other passwords. For example, the processor 106 may cause the database 114 to store the password 104 for a length of time as indicated by the integrity scoring parameter.

In some examples, the processor 106 may receive an application identifier from the user interface. The application identifier may identify an application using the password 104. For example, the application identifier may indicate which application is using the password 104 for authentication. Therefore, the password 104 may be associated with a certain application using the application identifier.

In some examples, the processor 106 may determine the integrity score 112 for the password 104 by querying the database 114 for a number of times that the password 104 has been used by the multiple users for the application identified by the application identifier. For example, the in-use passwords 116 and the previously-used passwords 118 may be associated with application identifiers. The processor 106 may query the database 114 to determine the number of in-use passwords 116 and/or previously-used passwords 118 that match both the password 104 and the application identifier of the password 104. In this manner, the likelihood that the password 104 may be compromised for a certain application may be determined.

In some examples, the processor 106 may also determine the integrity score 112 based on matches of the password 104 in a list of known compromised passwords. In some examples, the known compromised passwords list may be built from publicly available lists that contain compromised passwords from systems that have been breached. Therefore, in some examples, a hybrid approach may be performed to determine the integrity score 112. In this hybrid approach, the integrity score 112 may be determined based on the in-use passwords 116, the previously-used password 118 and the list of known compromised passwords.

In some examples, the integrity score 112 for a password 104 that is matched in the known compromised passwords list may not be binary. Instead, the matching used to determine the integrity score 112 may be a gradient scale of matching. In some cases, the compromised password may have been used once or many times. For example, if a password of “ilikezucchini” happened to be someone's password in a system that was hacked and was found once, this may not mean the password should never be used again. However, if the same password was found 5000 times in hacked systems, then the password may be considered to be more likely to be compromised.

In some examples, an application may use the described password integrity scoring via an online validation or authentication process by sending the password 104 to the processor 106 performing the integrity scoring. The application may then receive the integrity score 112 based on the likelihood of the password being compromised. In some examples, the requesting application may receive a fast response from the processor 106 with the integrity score 112. In some examples, the response may indicate the uniqueness of the password 104. In some examples, the response may also include a known compromised password flag indicating if the password 104 is included in a list of known compromised passwords.

As a new password 104 is checked against the database 114, the new password 104 may be added to the data available for scoring future passwords. In this way, the password integrity scoring may become stronger as more passwords 104 are added.

Being able to score a password 104 based on general usage may help in determining if the password 104 is susceptible to current and future hacking. In some examples described herein, the integrity of the password 104 is determined by tracking in-use passwords 116 and previously-used passwords 118.

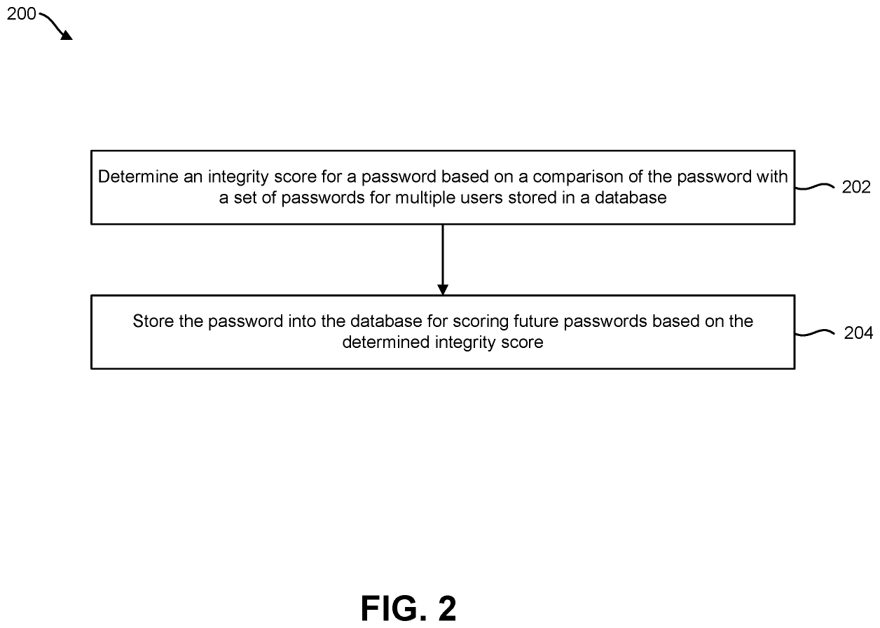

FIG. 2 is a flow diagram illustrating an example of a method 200 for password integrity scoring. The method 200 for password integrity scoring may be performed by, for example, the processor 106 of a computing device 102.

The processor 106 may determine 202 an integrity score 112 for a password 104 based on a comparison of the password 104 with a set of passwords for multiple users stored in a database 114. The set of passwords may include in-use passwords 116 and previously-used passwords 118 for the multiple users. The integrity score 112 may indicate the uniqueness of the password 104.

In some examples, the processor 106 may receive the password 104 from an automated system. For example, the processor 106 may receive the password 104 from a service (e.g., web service). In another example, the automated system may generate the password 104 and may send the password 104 to the processor 106.

In other examples, the processor 106 may receive the password 104 from a user interface. When a user attempts to access resources using an application, the user may be prompted to enter the password 104 into the user interface. The application and/or user interface may communicate the password 104 to the processor 106. In some examples, the processor 106 may receive the password 104 directly from the application and/or user interface. In other examples, the processor 106 may receive the password 104 from a web service acting as an intermediary for the application and/or user interface.

In some examples, the integrity score 112 may indicate the likelihood of the password 104 becoming insecure (e.g., compromised). In some examples, the integrity score 112 may be a gradient scale indicating the likelihood of the password becoming insecure.

In some examples, the integrity score 112 may be based on a number of times that the password is used. For example, the processor 106 may query the database 114 to determine the number of times the password 104 matches the in-use passwords 116 and/or previously-used passwords 118 for the multiple users. In some examples, determining the integrity score 112 for the password 104 may include determining the percentage of in-use passwords 116 and/or previously-used passwords 118 for the multiple users that match the password 104.

In an example, a high number of uses (e.g., matches) of the password 104 may result in a low integrity score 112. A low number of uses (e.g., matches) of the password 104 may result in a high integrity score 112.

The processor 106 may store 204 the password 104 into the database 114 for scoring future passwords. For example, the processor 106 may provide the password 104 to the database 114 to store the password 104. When a future password is provided to the processor 106 for integrity scoring, the saved password 104 may be used to determine the integrity score 112 of the future password.

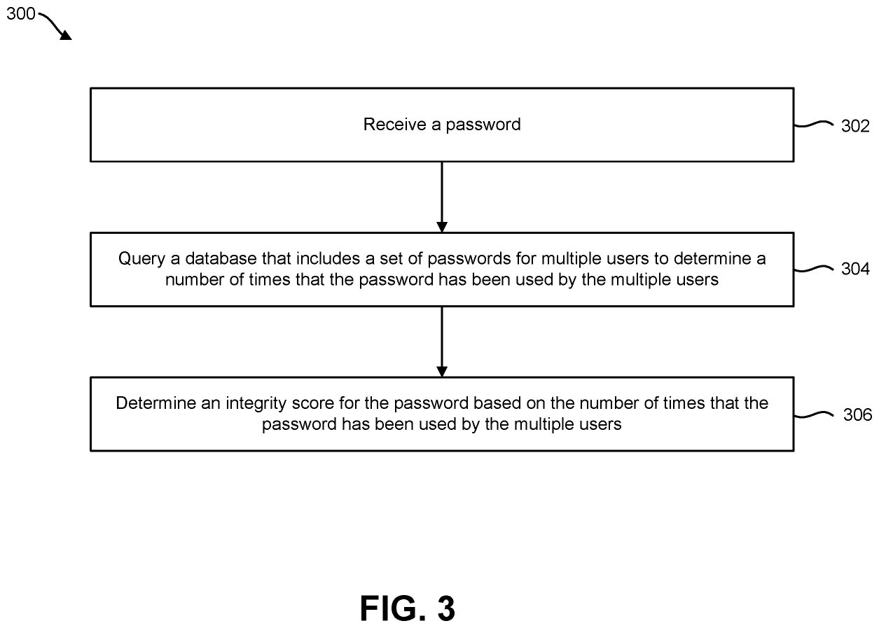

FIG. 3 is a flow diagram illustrating another example of a method 300 for password integrity scoring. The method 300 for password integrity scoring may be performed by, for example, the processor 106 of a computing device 102.

The processor 106 may receive 302 a password 104. This may be accomplished as described in FIG. 2. In some examples, the processor 106 may receive 302 the password 104 entered into a user interface. In other examples, the processor 106 may receive 302 the password 104 from a web service or automated system.

The processor 106 may query 304 a database 114 that includes a set of passwords for multiple users to determine the number of times that the password 104 has been used by the multiple users. The set of passwords may include in-use passwords 116 and previously-used passwords 118 for the multiple users.

In some examples, the processor 106 may query the database 114 to determine the number of times the password 104 matches the in-use passwords 116 and/or previously-used passwords 118 for the multiple users. In some cases, the match may be a complete (e.g., 100%) match. In other cases, the match may be a partial match of the password 104 to the in-use passwords 116 and/or previously-used passwords 118.

In some examples, there may be different ways to identify partial matches. For example, two passwords may be compared directly to determine how many characters match. In another example, variations on the password 104 can be compared to the database 114. This latter may be useful when the database 114 includes hashed values.

The processor 106 may determine 306 an integrity score 112 for the password 104 based on the number of times that the password 104 has been used by the multiple users. In an example, a high number of uses (e.g., matches) of the password 104 may result in a low integrity score 112. A low number of uses (e.g., matches) of the password 104 may result in a high integrity score 112.

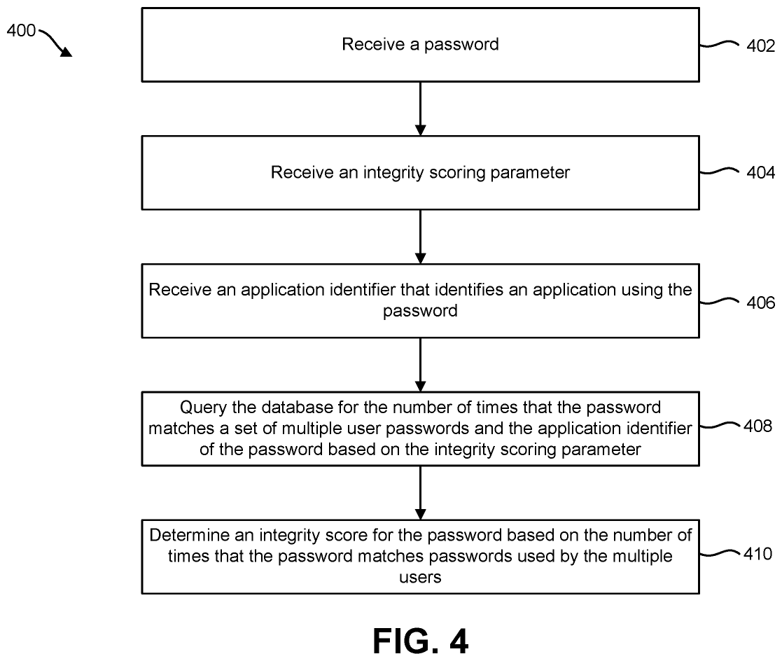

FIG. 4 is a flow diagram illustrating another example of a method 400 for password integrity scoring. The method 400 for password integrity scoring may be performed by, for example, the processor 106 of a computing device 102.

The processor 106 may receive 402 a password 104. This may be accomplished as described in FIG. 2.

The processor 106 may receive 404 an integrity scoring parameter. In an example, the integrity scoring parameter may include a length of time to store the password 104 for later integrity scoring against other passwords (e.g., other received passwords). In another example, the integrity scoring parameter may include a length of time to check for previously-used passwords 118. In this case, the integrity scoring parameter may indicate a timeframe for the previously-used passwords 118 to be included in password integrity scoring. In another example, the integrity scoring parameter may include whether password metadata may be shared among other application users of the system.

The processor 106 may receive 406 an application identifier that identifies an application using the password 104. The application identifier may identify an application using the password 104. For example, the application identifier may indicate which application is using the password 104 for authentication. Therefore, the password 104 may be associated with a certain application using the application identifier.

The processor 106 may query 408 the database 114 for a number of times that the password 104 matches a set of multiple user passwords and the application identifier of the password 104 based on the integrity scoring parameter. For example, the in-use passwords 116 and the previously-used passwords 118 for multiple users may be associated with application identifiers. The processor 106 may query 408 the database 114 to determine the number of in-use passwords 116 and/or previously-used passwords 118 that match both the password 104 and the application identifier of the password 104.

When querying 408 the database 114, the processor 106 may apply the integrity scoring parameter. For example, the query 408 may filter out previously-used passwords 118 that are older than a threshold amount indicated by the integrity scoring parameter. In another example, the database 114 may store the password 104 for later integrity scoring against other passwords for a length of time as indicated by the integrity scoring parameter.

The processor 106 may determine 410 an integrity score 112 for the password 104 based on the number of times that the password matches passwords used by the multiple users. In an example, a high number of matches of the password 104 may result in a low integrity score 112. A low number of matches of the password 104 may result in a high integrity score 112.

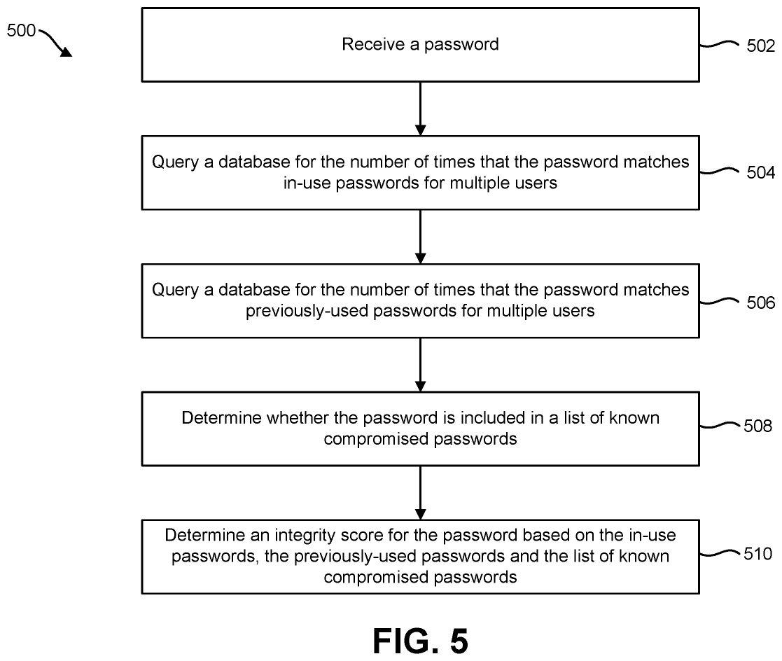

FIG. 5 is a flow diagram illustrating yet another example of a method 500 for password integrity scoring. The method 500 for password integrity scoring may be performed by, for example, the processor 106 of a computing device 102.

The processor 106 may receive 502 a password 104. This may be accomplished as described in FIG. 2.

The processor 106 may query 504 a database 114 for the number of times that the password 104 matches in-use passwords 116 for multiple users. In some cases, the match may be a complete (e.g., 100%) match of the password 104 to the in-use passwords 116. In other cases, the match may be a partial match of the password 104 to the in-use passwords 116.

The processor 106 may query 506 a database 114 for the number of times that the password 104 matches previously-used passwords 118 for multiple users. In some cases, the match may be a complete (e.g., 100%) match of the password 104 to the previously-used passwords 118. In other cases, the match may be a partial match of the password 104 to the previously-used passwords 118.

The processor 106 may determine 508 whether the password 104 is included in a list of known compromised passwords. In some examples, the list of known compromised passwords may be maintained at the computing device 102. In other examples, the processor 106 may query an internal or external service to determine 508 whether the password 104 is included in a list of known compromised passwords. If the password 104 is included in a list of known compromised passwords, the processor 106 may determine the number of systems that were breached using the password 104.

The processor 106 may determine 510 an integrity score 112 for the password 104 based on the in-use passwords 116, the previously-used passwords 118 and the list of known compromised passwords. In an example, a high number of matches of the password 104 may result in a low integrity score 112. A low number of matches of the password 104 may result in a high integrity score 112.

In some examples, the integrity score 112 is also based on whether the password 104 is included in a list of known compromised passwords. If the password 104 is included in a list of known compromised passwords, then the password 104 may receive a low integrity score 112. In some examples, the integrity score 112 may be a gradient based on the number of systems that were breached using the password 104.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
determining an integrity score for a password based on a comparison of the password with a set of passwords for multiple users stored in a database, the set of passwords comprising in-use passwords and previously-used passwords for the multiple users; and
storing the password into the database for scoring future passwords based on the determined integrity score.

2. The method of claim 1, wherein the integrity score indicates uniqueness of the password.

3. The method of claim 1, wherein the integrity score indicates a likelihood of the password becoming insecure based on a number of times that the password is used.

4. The method of claim 3, wherein the integrity score comprises a gradient scale indicating the likelihood of the password becoming insecure.

5. The method of claim 1, wherein determining the integrity score for the password comprises querying the database to determine a number of times the password matches the in-use passwords and previously-used passwords for the multiple users.

6. A method, comprising:
receiving a password;
querying a database comprising a set of passwords for multiple users to determine a number of times that the password has been used by the multiple users, the set of passwords comprising in-use passwords and previously-used passwords for the multiple users; and
determining an integrity score for the password based on the number of times that the password has been used by the multiple users.

7. The method of claim 6, wherein a high number of uses of the password results in a low integrity score.

8. The method of claim 6, wherein a low number of uses of the password results in a high integrity score.

9. The method of claim 6, wherein determining the integrity score for the password further comprises determining whether the password is included in a list of known compromised passwords.

10. A computing device, comprising:
a memory;
a processor coupled to the memory, wherein the processor is to:
receive a password;
compare the password with a set of passwords for multiple users stored in a database, the set of passwords comprising in-use passwords and previously-used passwords for the multiple users;
determine an integrity score for the password based on a number of times the password matches the in-use passwords and previously-used passwords for the multiple users; and
store the password into the database for scoring future passwords.

11. The computing device of claim 10, further comprising:
receiving an integrity scoring parameter; and
determining the integrity score based on the integrity scoring parameter.

12. The computing device of claim 11, wherein the integrity scoring parameter comprises a length of time to store the password for later validation against other passwords.

13. The computing device of claim 11, wherein the integrity scoring parameter comprises a length of time to check for previously-used passwords.

14. The computing device of claim 10, further comprising receiving an application identifier that identifies an application using the password.

15. The computing device of claim 14, wherein determining the integrity score for the password comprises querying the database for a number of times that the password has been used by the multiple users for the application identified by the application identifier.
